(19) United States
(12) Patent Application Publication
(10) Pub. No.: US 2015/0371295 A1
(43) Pub. Date: Dec. 24, 2015

(54) SYSTEM AND METHOD FOR CROSS-APPLICATION VIRTUAL GOODS MANAGEMENT

(71) Applicant: SOCIALPLAY INC., Mississauga (CA)

(72) Inventors: Tejpal GILL, Mississauga (CA); Alexander ZANFIR, Mississauga (CA)

(21) Appl. No.: 14/699,519

(22) Filed: Apr. 29, 2015

Related U.S. Application Data
(60) Provisional application No. 61/985,679, filed on Apr. 29, 2014.

(51) Int. Cl. G06Q 30/06; G07F 17/32; H04L 29/06

(52) U.S. Cl. CPC G06Q 30/0601; H04L 67/42; G07F 17/3255

(57) ABSTRACT

A system for cross-application virtual goods management is provided. The system provides application developers and users with mobility between applications for virtual goods. In further aspects, methods are provided for enabling mobility of virtual goods between applications.

### TECHNICAL FIELD

The following relates generally to a system and method for cross-application virtual goods management.

### BACKGROUND

The gaming market is growing across all demographics. A common element in the gaming market is the use of virtual goods. In most cases, gamers acquire virtual goods by performing activities, reaching goals or thresholds, or by purchasing them, whether with real or virtual currency. Typically, virtual goods provide gamers with desirable attributes, such as, for example, status, power, rank, or abilities. The purchase and sale of virtual goods for real currency is sometimes referred to as micro-transaction. Game developers provide virtual goods to gamers in order to, for example, encourage users to achieve goals, perform feats, or to generate income from micro-transactions.

In conventional applications, virtual goods are exclusive to one world and/or environment within the gaming community. Meanwhile social connectivity between gaming communities has become ubiquitous.

### SUMMARY

In one aspect, a system for the management of virtual goods sharable by a plurality of computer game applications defining gameplay environments is provided, the system comprising a virtual goods server configured to: store a plurality of virtual goods definitions to a virtual goods database, each virtual goods definition defining attributes of an associated virtual good to be made accessible to the plurality of computer game applications; receive requests for one of the virtual goods from computer game applications executing on client devices in communication with the virtual goods server upon a gamer in a gameplay environment performing a threshold action; and, transmit a corresponding one or more virtual goods definition to the computer game application to permit the gameplay environment to associate the one or more virtual goods with the gamer.

In another aspect, a method for the management of virtual goods sharable by a plurality of computer game applications defining gameplay environments is provided, the method comprising: storing a plurality of virtual goods definitions to a virtual goods database, each virtual goods definition defining attributes of an associated virtual good to be made accessible to the plurality of computer game applications; receiving requests, at a virtual goods server, for one of the virtual goods from computer game applications executing on client devices in communication with the virtual goods server upon a gamer in a gameplay environment performing a threshold action; and, transmitting a corresponding one or more virtual goods definition to the computer game application to permit the gameplay environment to associate the one or more virtual goods with the gamer.

### DESCRIPTION OF THE DRAWINGS

A greater understanding of the embodiments will be had with reference to the Figures, in which:

FIG. 1 is a block diagram of an example of a system providing cross-application virtual goods management;

FIG. 2 is a flowchart illustrating the process of giving gamer and/or user ownership of virtual goods using the virtual goods server as part of the system for cross-application virtual goods management;

FIG. 3 is a flowchart illustrating an example of an application loading virtual goods for a user;

FIG. 4 is a flowchart illustrating the process of a developer modifying an attribute of a virtual good;

FIG. 5 illustrates an embodiment of a user interface module for managing virtual goods, illustrating particularly a user interface screen showing login to a developer log-in screen;

FIG. 6 illustrates another embodiment of the user interface module, illustrating particularly a user interface screen showing a class of virtual goods;

FIG. 7 illustrates another embodiment of the user interface module, illustrating particularly a user interface screen for reviewing value, use, and other details of a given virtual good and for modifying properties of the virtual good;

FIG. 8 illustrates another embodiment of the user interface module, illustrating particularly a user interface screen for configuring value of a given virtual good;

FIG. 9 illustrates another embodiment of the user interface module, illustrating particularly a user interface screen for viewing user metrics;

FIG. 10 illustrates another embodiment of the user interface module, illustrating particularly another user interface screen for viewing user metrics; and

FIG. 11 illustrates a block diagram of an example of a virtual goods server schema providing attributes available in virtual goods management.

### DETAILED DESCRIPTION

Embodiments will now be described with reference to the figures. It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practised without these specific details. In other instances, well-known methods, procedures and components have not been described in detail so as not to obscure the embodiments described herein. Also, the description is not to be considered as limiting the scope of the embodiments described herein.

It will also be appreciated that any engine, unit, module, component, server, computer, terminal or device exemplified herein that executes instructions may include or otherwise have access to computer readable media, such as, for example, storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as, for example, computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Any application or module herein described may be implemented using one or more processors, computer readable media and computer readable/executable instructions that may be stored or otherwise held by such computer readable media and executed by the one or more processors

Systems and methods for cross-application virtual goods management are provided herein. An exemplary system comprises a virtual goods management engine, a user interface module, a virtual goods server and a shared virtual goods plugin that connects applications to the virtual goods server.

The system enables at least one developer to manage virtual goods acquired by gamers in the course of interaction with one or more distinct applications, which may be referred to as computer game applications. The developer manages the acquisition, use and exchange of the virtual goods. The system may further enable developers to provide and modify goods for the applications they develop. In still further embodiments, a developer can use the system to accept into the developer's application virtual goods acquired by gamers in other applications (whether commonly developed or not), or to provide virtual goods for sale for use in the developer's application in exchange for virtual or real currency. The system may thus save time for developers by enabling them to define virtual goods once and reuse the virtual goods across applications; as well as to potentially leverage the virtual goods defined by other developers, as well as to potentially leverage the acquisition of virtual goods by games of one application for further use of those goods in other applications.

It will be appreciated the terms “gamer” and “developer” are illustrative of the types of users of the present system and method; however, the systems and methods herein may interface with other types of users. These may include game developers, or developers of any application comprising virtual goods. For the foregoing reason, the terms “developer”, “application”, and “good” are used herein illustratively and in a non-limiting manner. Furthermore, the “good” could be substituted for a virtual object of any kind.

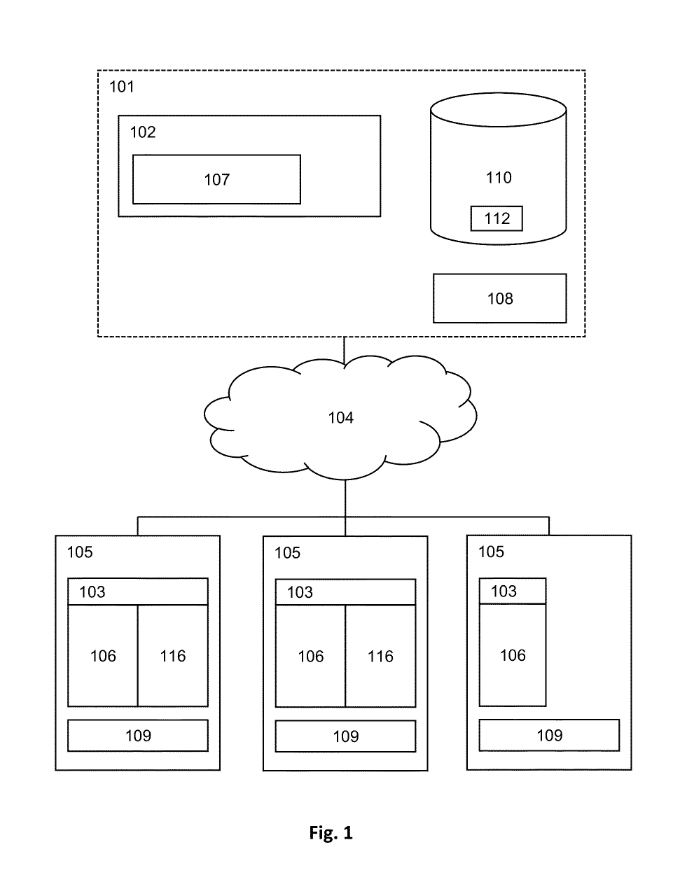

Referring now to FIG. 1, an exemplary system for cross-application goods management is provided. A virtual goods server (101) is configured to store definitions (112) in a virtual goods database (110) relating to virtual goods accessible by at least one application (106) which may operate on at least one client device (105) of a user, such as a gamer. The at least one application (106) executable by at least one client device (105) communicates with the virtual goods server (101) over a network (104). A shared virtual goods plugin (103) enables communication between the virtual goods server (101) and the at least one application (106) on the at least one client device (105).

Similarly, a user who may be a developer of the at least one application (106) may communicate with the server over a network (104) from a client device (105), as described in more detail below.

The gamer and/or the developer may be authenticated to the virtual goods server (101) upon running the at least one application (106) or otherwise accessing the server. These and other features are described in greater detail below.

The virtual goods server (101) may obtain from, store in the virtual goods database (110), and/or provides to, the at least one client device (105), as described below in greater detail, virtual goods definitions (112). Virtual goods definitions (112) comprise at least one attribute, such as, for example, world and/or environment administrator, world and/or environment, application, class, base item, item, virtual good identifier, storage, stack location, user, and credit. Virtual goods definitions may further comprise attributes such as, for example, name, properties, state, origin, detail, energy, image, description, behaviour, quality, owner identification, owner type or class, and location. Virtual goods definitions (112) may be customized for a particular user, game or application (106), client device (105), world and/or environment or network (104). Virtual goods definitions may be normalised for use across various applications (106), (116). Particularly, virtual goods definitions may be normalized for use by a particular user of a client device (105) across various applications (106),(116). Further, virtual goods definitions may be normalized for access by multiple users of client devices (105) across a single application (106) or multiple applications (106),(116).

The virtual goods plugin (103) may contain a version of a procurement service (108), and virtual goods data definitions from the virtual goods database (110), to allow the at least one application (106) to continue to function in the absence of a network connection on the at least one client device (105), and/or the at least one application (106), while withholding network requests to the virtual goods server (101), until a network connection becomes available. Re-establishment of the network connection may be determined at the operating system lever and/or through a polling service and/or push notification from the virtual goods server (101).

The at least one client device (105) may communicate with the virtual goods server (101) over any suitable network (104) or direct connection (not shown). The network (104) may provide for wired or wireless communication between the virtual goods server (101) and the client device (105). Wireless communication may be provided by various suitable protocols, such as, for example IEEE 802.11, GPRS, 3G, 4G, LTE. In embodiments, communication is provided over the Internet such that the functionality of the present systems and methods for cross-application virtual goods management is provided as a cloud-based service.

The at least one client device (105) may host at least one application (106), such as, for example, a computer game, and provides a user interface (109) for users, such as, for example, garners, to use and view the at least one application (106). The client device (105) may be a tablet device, smart phone, laptop, handheld computer or any other suitable device. The at least one client device (105) may comprise any one or more of a processor memory, input device, visual output device, camera, network module and location module.

The shared virtual goods plugin (103) enables communication between the at least one application (106) and the virtual goods server (101) over the network (104). In embodiments, applications (106) direct the shared virtual goods plugin (103) to make network requests to the virtual goods server (101). It will be appreciated that each client device (105) may communicate with the virtual goods server (101) by a single shared virtual goods plugin (103) which is common to all compatible applications, or by multiple shared virtual goods plugins (103) accessed by each application. The shared virtual goods plugin (103) interprets network responses from the virtual goods server (101) and converts the responses into data objects within the application (106). The data objects represent virtual goods which can be rendered as 2D or 3D models on the user interface (109). It will thus be appreciated that in some embodiments, while the definitions (112) comprise attributes associated with a virtual good, information for rendering a virtual good may be stored at least in part with the application at the device level. The shared virtual goods plugin (103) may temporarily store input received from the at least one client device (105) and/or a response to the at least one client device (105) from the virtual goods server (101) in temporary storage.

A virtual goods management engine (102) enables at least some types of users to manage definitions for virtual goods stored on the virtual goods database (110). The virtual goods management engine (102) may comprise a user interface module (107) for management of virtual goods by a particular type of user, such as a game developer. The virtual goods management engine (102) communicates with the virtual goods server (101), which stores the definitions of available virtual goods in the virtual goods database (110). The availability and definitions of virtual goods stored on the virtual goods database (110) may be modified using the virtual goods management engine (102). The user interface module (107) may enable user engagement with the virtual goods management engine (102). Although the virtual goods management engine (102) provides the user interface module (107), users may access the user interface module (107) from a client device (105), optionally through an appropriate browser.

The virtual goods server may provide a procurement service (108). The procurement service (108) enables users (such as garners) to acquire at least one of the virtual goods having a definition stored in the virtual goods database (110). The virtual goods procurement service (108) registers on the virtual goods server (101) any acquisitions by the at least one user of virtual goods in the at least one application (106), when the user has complied with at least one requirement for the acquisition thereof. The settings and behaviour of the virtual goods procurement service (108) are managed by the virtual goods management engine (102). Developers may selectively manage the settings of the virtual goods procurement service (108) via the user interface module (107), as described below in greater detail.

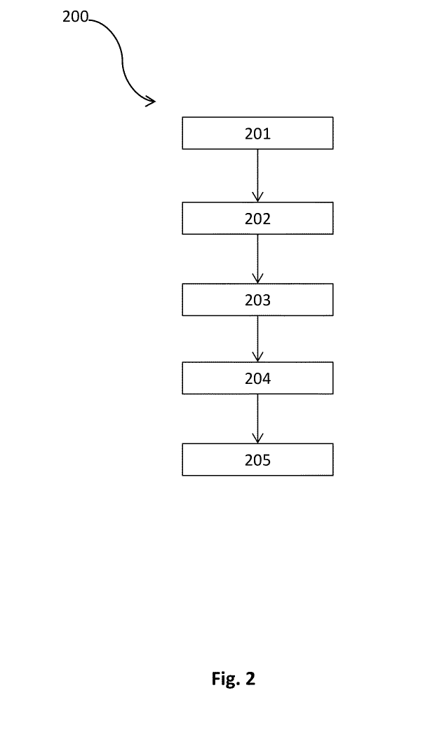

Referring now to FIG. 2, a method (200) is shown for providing a user with ownership of virtual goods, the operation of which may be carried out on the server side at least in part by the procurement service (108). The virtual goods are associated with a virtual goods definition (112) defined by a developer and stored in the database (110). In block (201), a virtual goods server (101) receives notification of a user action from an application executing on a client device (105) when a user, such as, for example, a gamer, performs a threshold action in an application. The threshold action may, for example, be an action the occurrence of which a developer of the application has determined should allow the user to receive one or more given virtual goods. The application may use a shared virtual goods plugin (103) to transmit the notification to the virtual goods server. In block (202), the virtual goods server verifies that the application and the associated user are authorised to instruct the virtual goods server. Specifically, a user's login credentials may be verified, authenticating the user to the server. For example, the user may input login credentials when accessing an application on a device (105) to authenticate the user to the server (101). If authorization is confirmed the method (200) may proceed to block (203). At block (203), the virtual goods server verifies that a criterion is satisfied such that the user is eligible to receive one or more virtual goods. The virtual goods server further determines which virtual goods the user is eligible to receive based on the threshold action performed. In block (204), the virtual goods server assigns ownership to the user of the virtual goods. In block (205), the virtual goods server transmits to the application a list of virtual goods owned by the user. In block (206), the application may then render at least one of the virtual goods received for display on the user interface (109) of the gamer. It will be appreciated that the method shown in FIG. 2 is provided as a procurement service provided by the virtual goods server. In embodiments, the threshold action may comprise one or more of: a purchase with real or virtual currency of a virtual good, attainment of a level in a virtual world, proximity with a virtual good dropped by an enemy in a virtual world, or other suitable threshold.

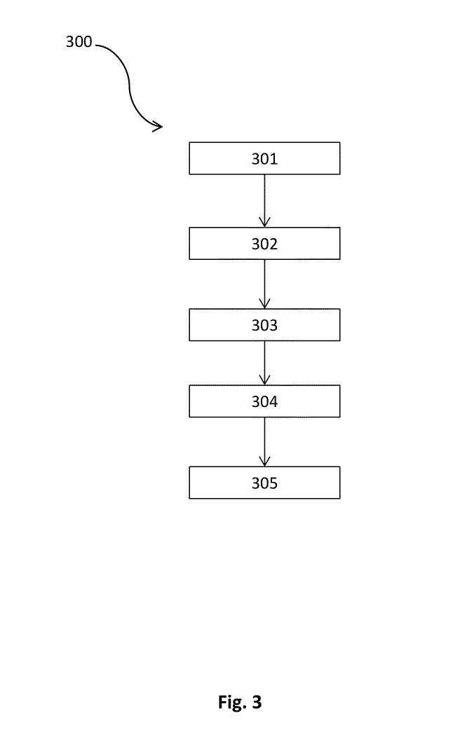

Referring to FIG. 3, a method (300) is shown for loading a user's virtual goods in an application. In block (301), a virtual goods server receives from a user's application a request to provide the application with the user's virtual goods. The application transmits the request via a virtual goods plugin, as previously described. In block (302), the virtual goods server verifies that the application and the associated user are authorized to access the virtual goods server, if authorization is confirmed the method proceeds to block (303). In block (303), the virtual goods server determines whether the user owns virtual goods. If the virtual goods server determines that the user owns virtual goods, the method proceeds to block (304). In block (304), the virtual goods server compiles a list of virtual goods owned by the user and transmits the list to the application. In block (305), the application renders the listed virtual goods in 2D or 3D.

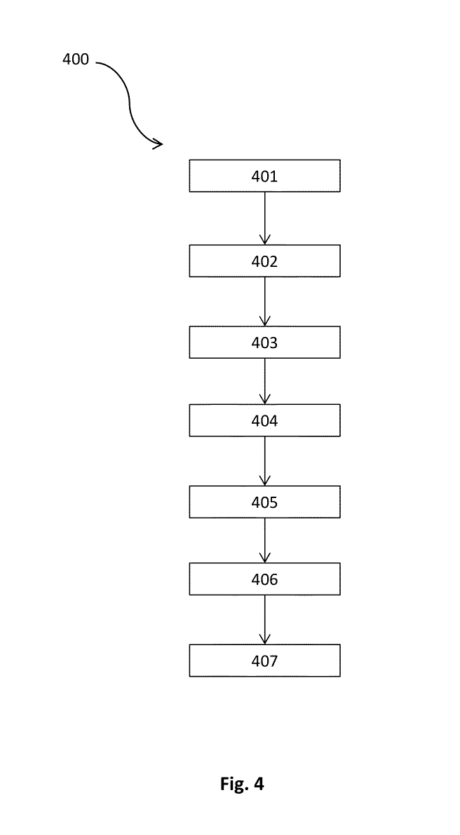

Referring to FIGS. 4 to 8, an exemplary user interface module (107) enables developer modification of virtual goods and their respective definitions across one or more applications. As previously described with reference to FIG. 1, the user interface module (107) enables input from at least one developer of at least one application (106) to the virtual goods management engine (102) such that the developer may select and customise the virtual goods and their respective definitions available to at least one user in at least one application (106), as further described below in greater detail. The user interface module may provide developer tools, such as, for example, tutorials, SDKs, live examples, apps, player management, the store and recipes for configuration.

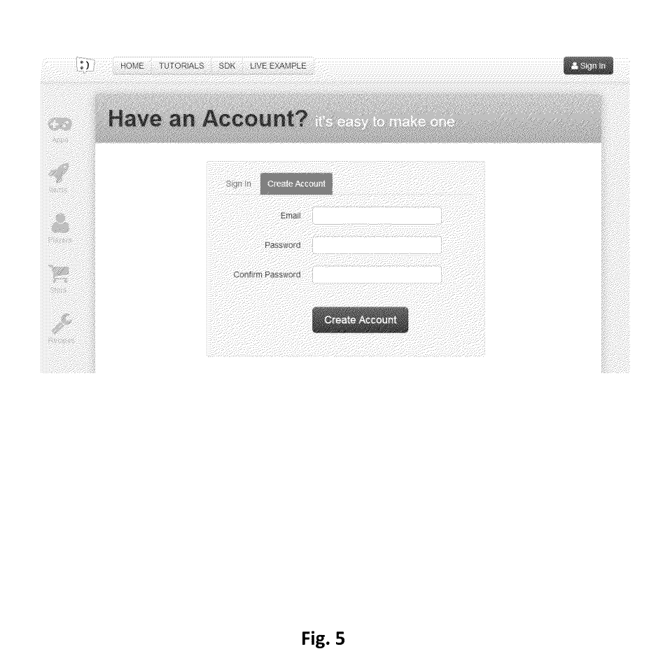

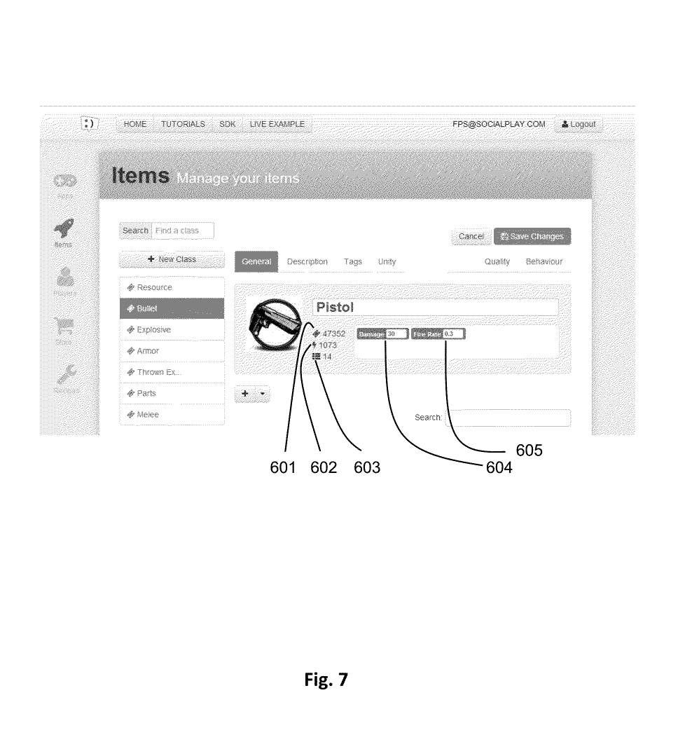

Referring to FIG. 4, a method (400) is provided for developer modification of a virtual good. In block (401) the virtual goods server receives from a user on a client device (105), such as a developer, a request for a list of virtual goods and their respective definitions. In some embodiments, the request is transmitted from the device (105) to the virtual goods server across a virtual goods plugin, as previously described. In block (402), the virtual goods server verifies that the device and the user are authorised to access the list of virtual goods and their respective definitions from the virtual goods server, if authorization is confirmed the method proceeds to block (403). The developer user may have to enter login credentials in the user interface module (107), as described in relation to FIG. 5, authenticating the developer to the server. In block (403), the virtual goods server compiles the list of virtual goods and their respective definitions available to the device. In block (404), the virtual goods server transmits the list to the device. In block (405), the developer modifies an attribute of a virtual good through the user interface module (107) which may communicate with the virtual goods management engine (102). Modification of attributes of a virtual good is described in additional detail below in relation to FIG. 7. In block (406), the virtual goods server (101) receives the new definition of the virtual good, or updates the existing definition, in accordance with the modifications made by the developer. In block (407), the virtual goods server stores the new or updated definition of the virtual good in the virtual goods database (110).

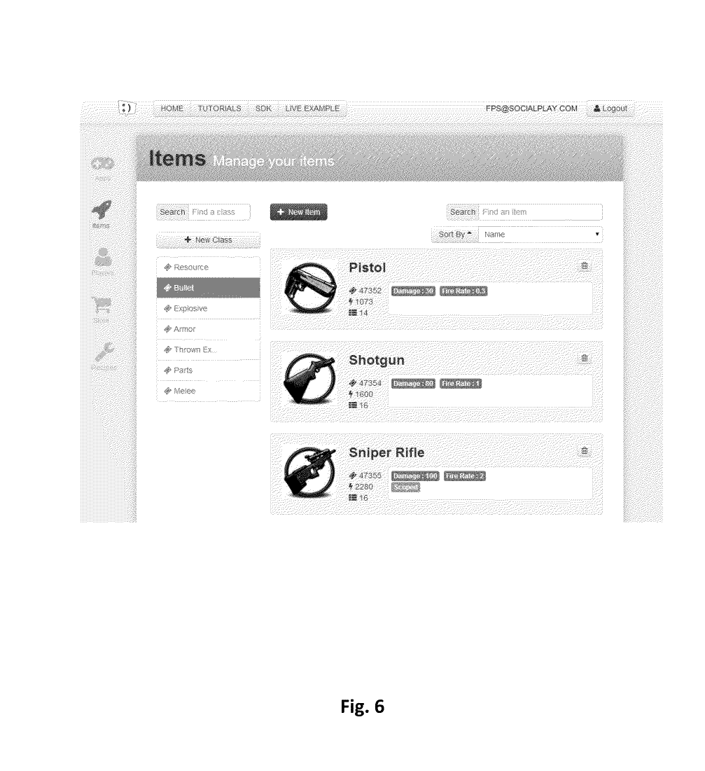

The developer may access the user interface (107) to provide a virtual goods definition to the virtual goods server (101) for a new virtual good created by the developer for use in his applications. In some embodiments, at least some of the virtual goods definitions stored in the server are preconfigured on the server for access by developers for use and modification in their applications. It will be appreciated that where a developer modifies the definition of a preconfigured virtual good, modification of the virtual good may be limited to the developer's applications or could be shared amongst applications for a plurality of developers. This decision may be left to the developer. Referring to FIG. 5, a developer login and account sign-in user interface is shown. A developer may access the cross-application virtual goods management system by registering an account on the cross-application virtual goods management system and/or signing into the account by entering user login credentials into developer login and/or account sign-in fields. User credentials may comprise one or more of e-mail address and password, but it will be appreciated that other suitable credentials may be used. The credentials entered in the developer login and account sign-in user interface may be provided to a virtual goods management engine in communication with a virtual goods server. The virtual goods server determines whether the credentials belong to an authorised developer. If they do, the virtual goods server may determine the virtual goods and their respective attributes available to the developer. Referring to FIG. 6, a developer class and virtual goods management interface is provided in which a developer may selectively add, delete and modify classes of virtual goods to be made available in at least one application. As shown, the developer may view the types of virtual goods and their respective definitions available within the classes of available virtual goods. For example, the class “Bullets”, which is an example of a class, may comprise the virtual goods “Pistol”, “Shotgun” and “Sniper Rifle”; the virtual good “Pistol” is defined by its properties, the properties comprising “Damage: 30” and “Fire Rate: 0.3”. These properties relate to the effect of the use of the virtual goods of that class within a game. For example, the numerical value for a “Damage” property for a good likely would be correlated with the amount of damage inflicted on a target within the game by use of that good. It will be appreciated that other classes comprising other goods having other properties are contemplated.

Referring now to FIG. 7, a virtual goods management interface is provided. The virtual goods management interface enables a developer to view a plurality of attributes for given goods. In the embodiment shown, the interface provides a summary of three particular attributes, a first (601) being an icon corresponding to a unique identifier for the virtual good as stored in the virtual goods database; a second (602) being an icon corresponding to, for example, energy for the associated virtual good (in this case, energy means a value of the good relative to other goods available to the user, game, or environment); and a third (603) being an icon corresponding to, for example, the number of variations of the good (in this case, variations means a type within a class that may allow the developer to assign power, among other attributes, to the good. For example, a Pistol might have a Powerful Pistol, Weak Pistol, and Gold pistol; in that case, the number shown could be 3). The interface also provides properties of a particular virtual good, such as damage (604) and fire rate (605) for the illustrated virtual good titled “Pistol”. Furthermore, the interface may provide searching and sorting functionality. The virtual goods may be indexed, optionally by a virtual goods server, and returned to the user interface module based on text or property matches as input, or based on the unique identifier (601). The developer may also sort by virtual good attributes, such as, for example, name, world, class, etc.

Referring again to FIG. 7, the virtual goods properties and/or attributes can be viewed and modified when the developer inputs numerical values that may be processed in order to determine the definition of a virtual good in relation to all virtual goods available in a given application. For instance, in the example shown in FIG. 7, the “Pistol” previously referred to has a definition comprising numerous customisable properties. The developer may modify the “Damage” or “Fire Rate” properties by selecting their icons in the interface and entering desired values. it will be appreciated that when the properties of a virtual good are modified, in-game behaviour of the virtual good may be affected correspondingly. Accordingly, for example, modification the fire rate property may cause a user's pistol to fire at a different rate in the gameplay environment of an application.

As shown in FIGS. 6 and 7, virtual goods are graphically depicted in the user interface module. A representative 2D or 3D image of the virtual good may be displayed alongside configuration options through the user interface module.

Class creation and virtual good behaviour modification may thus occur through the user interface module, using the virtual goods management engine and may be stored in the virtual goods database (110). The developer may, but is not limited to, creating, modifying, deleting, hiding, removing and sorting any property of a given virtual good using the user interface module provided by the virtual goods management engine.

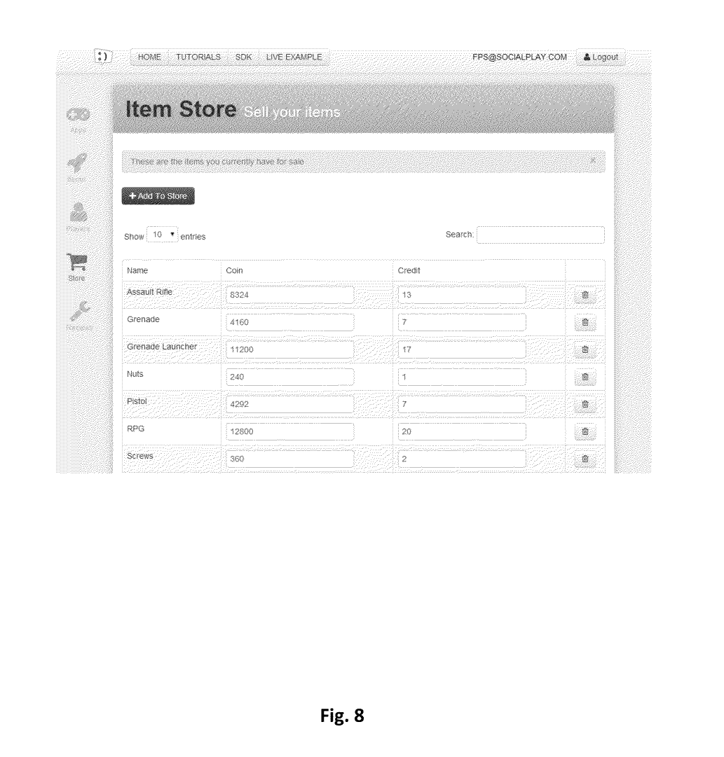

Referring to FIG. 8, the developer may provide virtual goods that may be for sale and/or available for trade to gamers. Which virtual goods may be for sale and their values, whether with respect to virtual currency, a micro-transaction or gamer earned credit though play, may be configured by the developer through the user interface module (107). The virtual good value may be viewed and modified when the developer inputs numerical values that may be processed in order to determine a purchase, trade or any other valuation of the virtual good in relation to all virtual goods available to the developer within the extended application world and/or environment. The developer may create, modify, delete, hide, remove and sort any property of the virtual good.

The developer may also configure the user interface module to display the number of virtual goods available in a virtual store. A search function may be provided to allow the developer to search and sort virtual goods by attributes, such as, for example, name, world, class, etc.

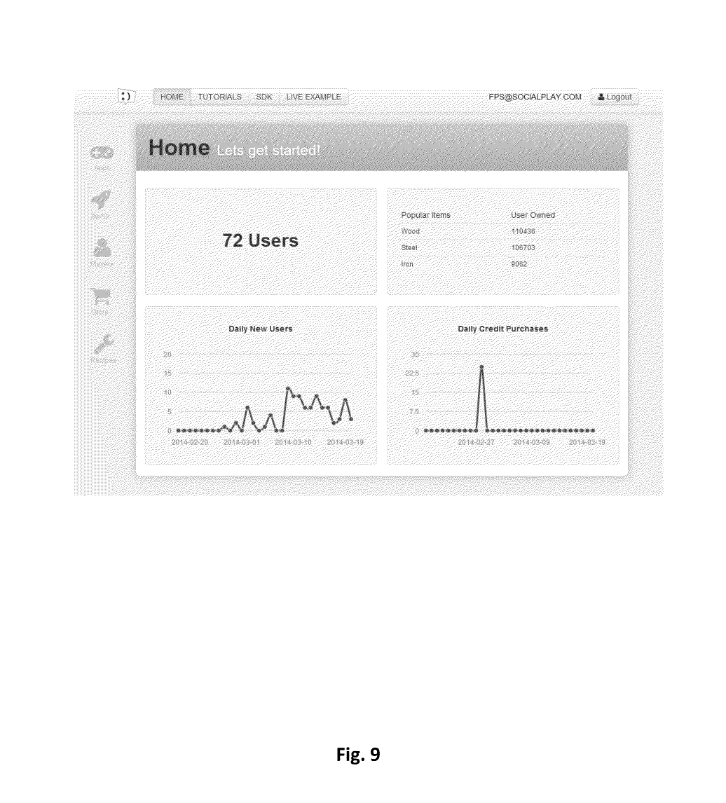

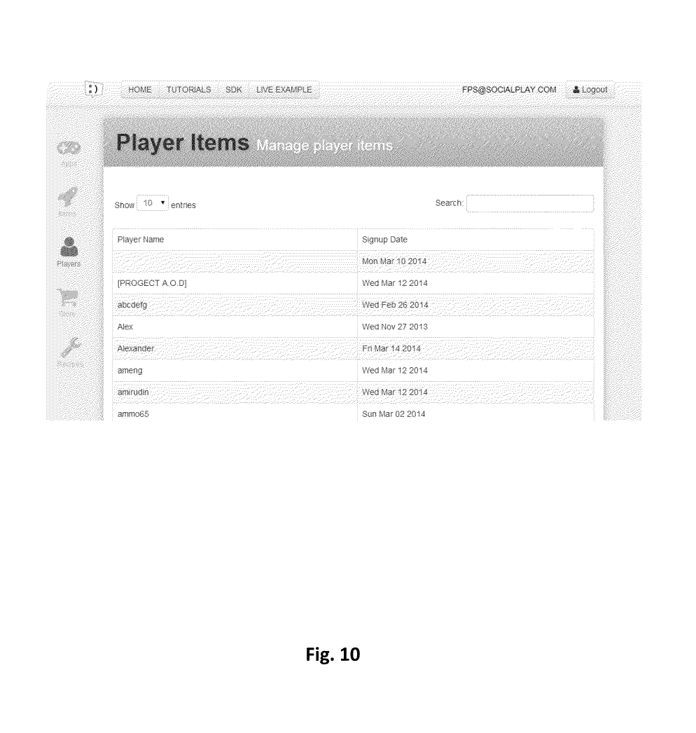

Referring to FIGS. 9 and 10, an interface of user interface module (107) is illustrated in which a game developer may be shown analytics relating to all or some applications managed by the developer. For example, the number of users of any one or more of the applications managed by a developer may be displayed by the interface. It will be appreciated that other analytics may be depicted, including, for example, new users of the applications managed by the developer, or the number of credits or virtual goods purchased by users of the applications managed by the developer.

As illustrated in FIG. 9, the developer can view the number of users, the number of users categorized by date of first use of the application, popular virtual goods across users and/or the applications managed by the developer, such as, for example, an extended world and/or environment. Furthermore, through the display unit, the developer may view the purchase or trade rate of virtual goods by day.

Another example of a user interface module providing the above functionality is shown in FIG. 10. Through the user interface module, a developer may manage gamer and/or player virtual goods. The developer may select the number of players and corresponding details to view through the user interface module. Furthermore, the developer may search by various attributes related to gamer and/or player management including gamer and/or player name, signup date, etc.

Actions the developer can perform include but are not limited to viewing the number of gamers of an application, virtual goods owned by groups or individual gamers, information that may identify gamers, application use generally, original use date, frequency of use of virtual goods, frequency of use of class, incremental user activity whether by the minute, hour, day, week, month, or any increment so configured by the user. Further, virtual goods definitions may be modified for particular gamers, such as removing access to particular virtual goods for some gamers or groups of gamers of a developer's applications.

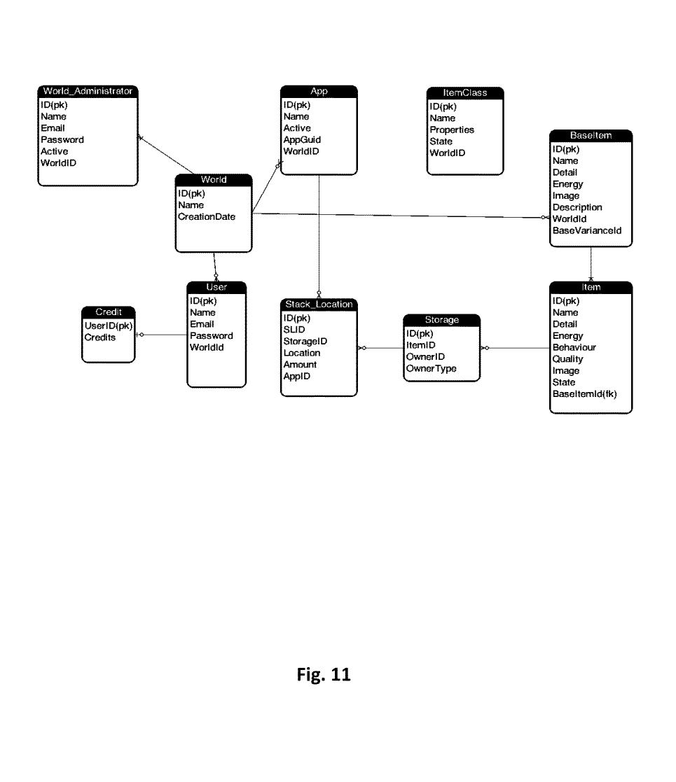

Referring to FIG. 11 a virtual goods database may store definitions of virtual goods according to a schema providing for relationships between the attributes which the definitions comprise. The definition may comprise any one or more of the attributes listed in FIG. 11. Of course, these attributes may be modified by a virtual goods management engine, as previously described. It will be further appreciated that other attributes may be stored on the virtual goods server.

A developer can access the interface (107) to accept into the developer's application virtual goods acquired by gamers in other applications (whether commonly developed or not). The interface (107) may identify virtual goods acquired by gamers in other applications than the developer's applications. Optionally, the developer may modify the virtual goods definitions of virtual goods acquired by gamers in other applications once accepted into the developer's applications.

Although the following has been described with reference to certain specific embodiments, various modifications thereto will be apparent to those skilled in the art without departing from the spirit and scope of the invention as outlined in the appended claims. The entire disclosures of all references recited above are incorporated herein by reference.

What is claimed is:

1. A system for the management of virtual goods sharable by a plurality of computer game applications defining gameplay environments, the system comprising a virtual goods server configured to:
a. store a plurality of virtual goods definitions to a virtual goods database, each virtual goods definition defining attributes of an associated virtual good to be made accessible to the plurality of computer game applications;
b. receive requests for one of the virtual goods from computer game applications executing on client devices in communication with the virtual goods server upon a gamer in a gameplay environment performing a threshold action; and
c. transmit a corresponding one or more virtual goods definition to the computer game application to permit the gameplay environment to associate the one or more virtual goods with the gamer.

2. The system of claim 1, wherein the virtual goods server is configured to store an attribute associating each virtual goods definition with the gamer, and to provide each virtual goods definition associated with the gamer to the client device corresponding with the gamer.

3. The system of claim 1, wherein the virtual goods server further comprises a virtual goods management engine for modifying at least one definition in response to receiving a modification request from a client device in use by a developer.

4. The system of claim 3, wherein the virtual goods management engine stores an attribute associating one or more of the virtual goods definitions with the developer, and wherein the one or more definitions associated with the developer can be modified by the engine in response to the request.

5. The system of claim 4, wherein modifying a definition comprises adding or deleting a definition to the virtual goods server.

6. The system of claim 4, wherein modifying a definition comprises modifying attributes of a virtual good such that gameplay behaviour of the virtual good in the gameplay environment is affected.

7. The system of claim 4, wherein the virtual goods management engine communicates with a user interface module in at least one application for offering at least one virtual good for sale by real currency, virtual currency, or real and virtual currency.

8. A method for the management of virtual goods sharable by a plurality of computer game applications defining gameplay environments, the method comprising:
a. storing a plurality of virtual goods definitions to a virtual goods database, each virtual goods definition defining attributes of an associated virtual good to be made accessible to the plurality of computer game applications;
b. receiving requests, at a virtual goods server, for one of the virtual goods from computer game applications executing on client devices in communication with the virtual goods server upon a gamer in a gameplay environment performing a threshold action; and
c. transmitting a corresponding one or more virtual goods definition to the computer game application to permit the gameplay environment to associate the one or more virtual goods with the gamer.

9. The method of claim 8, further comprising storing an attribute associating each virtual goods definition with the gamer, and providing each virtual goods definition associated with the gamer to the client device corresponding with the gamer.

10. The method of claim 8, further comprising a virtual goods management engine modifying at least one definition in response to receiving a modification request from a client device in use by a developer.

11. The method of claim 10, further comprising the virtual goods management engine storing an attribute associating one or more of the virtual goods definitions with the developer, and wherein the one or more definitions associated with the developer can be modified by the engine in response to the request.

12. The method of claim 10, wherein modifying a definition comprises adding or deleting a definition to the virtual goods server.

13. The method of claim 10, wherein modifying a definition comprises modifying attributes of a virtual good such that gameplay behaviour of the virtual good in the gameplay environment is affected.

14. The method of claim 10, further comprising the virtual goods management engine communicating with a user interface module in at least one application and offering at least one virtual good for sale by real currency, virtual currency, or real and virtual currency.
